(19) United States
(12) Patent Application Publication
(10) Pub. No.: US 2025/0281948 A1
(43) Pub. Date: Sep. 11, 2025

(54) Method for Detecting Dirt and Cleaning with Piezo Transducer, Device, Automotive Part and Vehicle

(71) Applicant: Motherson Innovations Company Limited, London (GB)

(72) Inventors: Matthias KOLLER, Stuttgart (DE); Romeo WIECZOREK, Stuttgart (DE)

(21) Appl. No.: 19/068,331

(22) Filed: Mar. 3, 2025

(30) Foreign Application Priority Data
Mar. 8, 2024 (DE) 10 2024 106 752.7

(51) Int. Cl. B08B 7/02; B08B 7/04; G01N 29/24

(52) U.S. Cl. CPC B08B 7/028; B08B 7/04; G01N 29/2437

(57) ABSTRACT

The present disclosure refers to a method for detecting dirt and for cleaning a surface of a lens system or lens cover of a camera device with at least one piezo transducer mechanically coupled to said surface, wherein the method comprises the following steps: a) activating the at least one piezo transducer for removing dirt via vibrations, b) determining the result of the dirt removing in step a) via a mass resonance measurement method, c.1) in case the determined mass has not changed, repeating the sequence of steps a) and b), c.2) in case the determined mass has been reduced below a first threshold, stopping the method, c.3a) in case the mass determined in step b) is above a second threshold conducting an optical blockage detection method, and c.3b) in case an optical blockage is detected in the field of view of the camera device in step c.3a), initiating at least one countermeasure, or in case no optical blockage is detected in the field of view of the camera device in step c.3a), stopping the method. It also refers to a device for conducting said method and an automotive part with such a device.

### CROSS-REFERENCE TO RELATED APPLICATION

This application claim priority to German Patent Application No. DE 10 2024 106 752.7, filed on Mar. 8, 2024, the entirety of which is incorporated herein by reference.

### FIELD

The present disclosure refers to a method for detecting dirt and for cleaning a surface of a camera device, with at least one piezo transducer mechanically coupled to said surface, and a device for implementing said method. Both, the method and the device are suited to be used with a drive assistant system, preferably for an autonomously driving vehicle. Further, the present disclosure refers to an automotive part with said device and a vehicle with such an automotive part.

### BACKGROUND

Conventional cleaning systems in vehicles make usage of water. For example, an exterior rear view device is known from US 2023/017426 A1, which comprises a base assembly configured to be mounted to a vehicle for moveably supporting a head assembly of the exterior rear view device, the base assembly comprising: a camera with a lens; a cleaning system with a nozzle for dispensing a cleaning fluid like water onto the lens; a base frame; a base cover, comprising a plurality of cover pieces, which provide a first opening for the lens and a second opening for the nozzle; and a camera cradle mounted to the base frame for holding both the camera and the nozzle.

As water has to be stored in contains within the vehicle, it has to be refilled in regular intervals. This is burdensome. Other cleaning methods avoiding the usage of water are also known in prior art. US 2018/154406 A1 discloses a lens cleaning system with foreign material detection. This lens cleaning systems uses a transducer mechanically coupled to a lens, a driver to provide an oscillating drive signal to the transducer and a controller to control the drive signal frequency to vibrate the lens at frequencies in a range of interest. The controller determines a measured resonant frequency of the lens cleaning system in the range of interest according to a transducer feedback signal and selectively performs a lens cleaning operation if the measured resonant frequency differs from a baseline resonant frequency of the lens cleaning system for a clean lens.

A system such as an autonomous vehicle's perception system of US 2023/068848 A1 will identify and classify an obstruction in a field of view of an image capturing device. The system will receive a sequence of image frames from the image capturing device. For each of the image frames, the system will segment the image frame into a regions of interest (ROIs), and the system will use a classifier to assign a classification to each ROI. The classification indicates whether the ROI is clear or obstructed. The system will aggregate the classifications for each ROI to determine an aggregate classification. When an obstructed classification persists for a threshold number of image frames, the system will classify the image capturing device as obstructed, and it will generate a function request that, when executed, will cause a system of which the image capturing device is a component to perform a function.

US 2023/145395 A1 relates to a method for cleaning a protective device for a drive assist system, comprising an optical sensor having an optic, the protective device having an optical element arranged upstream of the optic and having an inner surface and an outer surface and being movably mounted about an axis of rotation, the method comprising the following steps: processing a succession of images acquired by the optical sensor when the optical element is rotating, so as to detect a generally circular or semi-circular shape which is centered on the axis of rotation of the optical element and which is generated by dirt deposited on the outer surface, and triggering at least one action for cleaning the outer surface of the optical element if the shape is detected.

U.S. Pat. No. 11,865,592 B2 describes a cleaning device, which includes a protection cover, a vibrator, a piezoelectric driver, and a signal processing circuit. When the signal processing circuit determines that foreign matter is adhered to a surface of the protection cover, it controls the piezoelectric driver such that vibration of the protection cover has a vibration acceleration of about 1.5×105 m/s2. When the signal processing circuit determines that the foreign matter is adhered to the surface of the protection cover when control of the driver such that vibration of the protection cover has a prescribed vibration acceleration, the protection cover is warmed with a warmer. After the protection cover is warmed, the signal processing circuit controls the piezoelectric driver such that vibration of the protection cover has a resonant frequency.

An apparatus according to US 2018/0 326 462 A1 includes a mass detection circuit coupled to a surface covered with a plurality of electrodes. The mass detection circuit is configured to detect a mass of a first droplet present on the surface. The apparatus further includes a transducer circuit coupled to a transducer, which is coupled to the surface and form a lens unit. The transducer circuit configured to excite a first vibration of the surface at a resonant frequency to form a high displacement region on the surface. The apparatus also includes a voltage excitation circuit coupled to the plurality of electrodes. In response to the detection of the mass of the first droplet, the voltage excitation circuit is configured to apply a sequence of differential voltages on one or more consecutive electrodes which moves the first droplet to the high

Without using water often the cleaning is not satisfying, in particular in case of dry dirt.

### SUMMARY

Embodiments of the present disclosure provide a dirt detection and cleaning method with at least one piezo transducer overcoming the drawbacks of the prior art.

A method is provided for detecting dirt and for cleaning a surface of a camera device, in particular of a lens system or lens cover of the camera device, with at least one piezo transducer mechanically coupled to said surface, wherein the method comprises the following steps: a) activating the at least one piezo transducer for removing dirt via vibrations, and b) determining the result of the dirt removing in step a) via a mass resonance measurement method, and c.1) in case the determined mass has not changed, repeating the sequence of steps a) and b), c.2) in case the determined mass has been reduced below a first threshold stopping the method, c.3a) in case the mass determined in step b) is above a second threshold conducting an optical blockage detection method, and c.3b) in case an optical blockage is detected in the field of view of the camera device in step c.3a), initiating at least one countermeasure, or in case no optical blockage is detected in the field of view of the camera device in step c.3a), stopping the method.

In embodiments, the at least one piezo transducer is activated at least partly during the conduction of the mass resonance measurement method for migration and/or burst of particles of dirt.

Embodiments of the present disclosure may be characterized in that the at least one piezo transducer may be controlled at different frequencies, the mass resonance measurement method may be controlled at different frequencies, and/or the drive signal frequency of the at least one piezo transducer differs from the frequency used with the mass resonance measurement method.

Further, it is proposed that a baseline resonant frequency measured for the clean surface with the mass resonance measurement method is compared with the frequency measured in each step of conducting the mass resonance method for the determining the mass or mass change of dirt.

Still further, it is proposed that the at least one piezo transducer is activated at least partly during the conduction of the optical blockage detection method for determining a movement of an optical blockage relative to an unchanged background, in particular with a low frequency of the at least one piezo transducer, and/or a change in shape of an optical blockage when a vibration is applied compared to a non-vibrating state, in particular with a high frequency of the at least one piezo transducer.

In this context, it is also proposed that the at least one piezo transducer may be controlled at different frequencies, the optical blockage detection method may be controlled at different frequencies, and/or the drive signal frequency of the at least one piezo transducer differs from the frequency used with the optical blockage detection method.

According to embodiments of the present disclosure it is proposed that step a) is initiated in case an initial dirt mass detection via the mass resonance measurement method determines a mass above a third threshold value, when activating the camera device, when approaching a vehicle with the camera device with a key, when starting the vehicle with the camera device, after the expiration of a pre-set time interval, at a certain point of time or manually.

It is also proposed that the at least one countermeasures comprises outputting a signal, in particular in form of a message to remove dirt, activating at least one air valve for removing dirt, activating at least one mechanical cleaning device, in particular comprising a wiper and/or provided by a key, and/or activating at least one water valve for removing dirt.

Still further, it is proposed that the kind of countermeasure(s), the amount of countermeasures and/or the sequence of countermeasures depends on the mass and/or mass change determined by at least one of the steps of conducting the mass resonance measurement method, and/or the blocked optical flow, the amount of visible dirt, the amount and/or size of blocked pixels of an image area, the resolution of the image area and/or an area monitored by the camera device.

Embodiments can be characterized in that the activation of the at least one water valve is the last countermeasure selected in a sequence of countermeasures.

In embodiments, after the at least one countermeasure the at least one piezo transducer is activated, a further resonance mass measurement method is conducted and/or a further optical blockage detection method Is conducted.

Embodiments of the present disclosure also provide a device for detecting dirt and for cleaning a surface of a camera device, in particular of a lens system or lens cover of the camera device, with at least one piezo transducer mechanically coupled to said surface, wherein the device is adapted to conduct the method according to the present disclosure.

The device according to the present disclosure may comprise ultrasonic surface cleaning electronics with at least one configurable digital signal processor, a piezo driver connected to the at least one piezo transducer of the camera device, at least one power supply pin and an evaluation module.

It is proposed that the ultrasonic surface cleaning electronics comprises a pulse width generator and a pulse width controller and/or at least one sensor, in particular comprising a current sensor, a voltage sensor and/or a temperature sensor.

Further, it is proposed that the camera device comprises a housing, a printed circuit board with at least one optical sensor, a lens cover, the lens system and the piezo transducer mechanically connected to the lens cover and arranged within the housing.

Still further it is proposed that the lens system is arranged between the lens cover and the printed circuit board or comprise the lens cover.

According to one aspect of the present disclosure the piezo transducer has a ring form and/or at least partly embraces the lens system.

According to a further aspect the housing is formed with a recess, wherein the lens cover and the piezo transducer extend into the recess, with preferably an elastic sealing means being arranged between the housing and the lens cover.

The present disclosure also provides an automotive part, in particular in form of a rear view device and/or drive assistance device of a motor vehicle, with at least one device according to the present disclosure.

Finally, the present disclosure also provides a vehicle, in particular an autonomously driving vehicle with an automotive part according to the present disclosure.

It is proposed that at least one vehicle sensor output and/or driving data are controlling the piezo transducer vibration, the mass resonance measurement method and/or the optical blockage detection method.

Thus, with the present disclosure optimum means for detecting dirt and cleaning a surface of a camera device, especially a lens system or lens cover, with minimal water consumption are provided. That is because one or more piezo transducers are used for removing dirt particles and also ice and condensation by vibrating. Further, the vibrations may also lead to a targeted droplet migration, in particular during a mass resonance measurement method for determining a mass or mass change of dirt. Still further, vibrations may be used for detecting an optical blockage even in case the camera device is not moving. Air from air nozzles may be used for loose dry dirt, and water from water nozzle may to be used only as last resort to remove residual dirt.

The minimum particle size, in particular dirt or droplet size, that may be determined depends on the resolution of the camera device. Activation of the piezo transducer(s) may only be started when particles have reached this minimum size or exceeds the same.

### BRIEF DESCRIPTION OF THE DRAWINGS

The foregoing summary, as well as the following detailed description, will be better understood when read in conjunction with the appended drawings. For the purpose of illustration, certain examples of the present disclosure are shown in the drawings. It should be understood, however, that the present disclosure is not limited to the precise arrangements and instrumentalities shown. The accompanying drawings, which are incorporated in and constitute a part of this specification, illustrate an implementation of systems, apparatuses, and methods consistent with the present disclosure and, together with the detailed description, serve to explain advantages and principles consistent with the present disclosure, wherein:

FIG. 1 is a schematic diagram of a dirt detection and cleaning device according to the present disclosure with ultrasonic lens cleaning electronics connected to a camera device;

FIG. 2 a perspective view of a camera device for an automotive part according to the present disclosure; and

FIG. 3 is a flow chart of a dirt detection and cleaning method according to the present disclosure.

### DETAILED DESCRIPTION

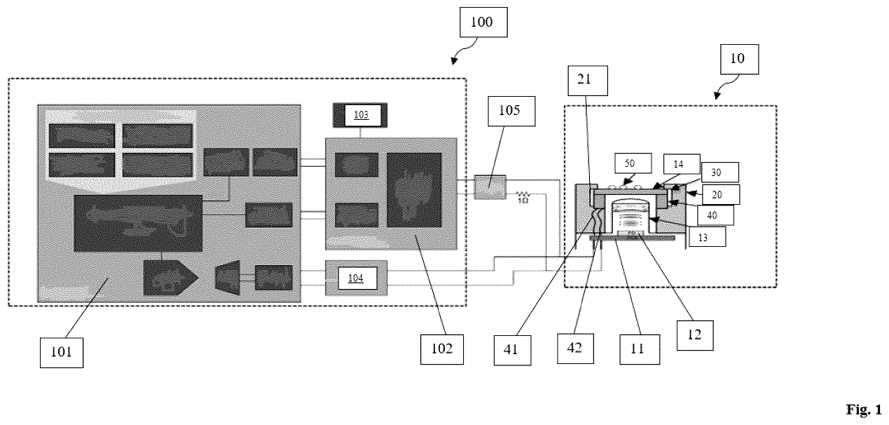

A dirt detection and cleaning device according to the present disclosure with ultrasonic lens cleaning electronics 100 connected to a camera device 10 is shown in FIG. 1. The ultrasonic lens cleaning electronics 100 may comprise a configurable digital signal processor (DSP) 101 for ultrasonic lens cleaning with current and voltage sensing and pulse width modulation (PWM) output like the commercially available ULC1001 of Texas Instruments. The ULC1001 is a configurable PWM modulator with current and voltage sensing capabilities specifically for piezo based lens cleaning systems. Further, the ultrasonic lens cleaning electronics 100 may comprise a piezo driver 102 like the DRV2901 as well as an evaluation module (EVM), in particular in form of the so-called ULC1001-DRV290XEVM, being an evaluation module (EVM) showcasing a two-chip solution of the ULC1001 and the DRV2901. The pair may work together to provide self-cleaning functionality with features like temperature detection, lens fault detection and contaminant detection for automatic cleaning.

A power supply pin 103, like a PVDD, is connected to the piezo driver 102. The DSP 101 is connected via the piezo driver 102 and filters 105 to a printed circuit board (PCB) 11 of the camera device 10. Further, the DSP 101 is connected via resistive dividers 104 to the PCB 11.

The camera device 10 comprises in addition to the PCB 11, a PD 12, being an image sensor, which is arranged on the PCB 11, and a lens system 13 arranged above the PD 12 within a housing 20 being covered with a lens cover 14 and sealed via a gasket 30. The lens cover 14 may be part of the lens system 13 or provided separate therefrom. The housing 20 is formed with a recess 21 for mounting the lens cover 14, the gasket 30 and a piezo transducer 40 below the lens cover 14 as well as in mechanical contact thereto and at least partly surrounding the lens system 13. The piezo transduce 40 is connected to the PCB 11 via cables 41, 42. The camera device 10 may have a circular cross-section such that the piezo transducer 13 may be in form of a ring.

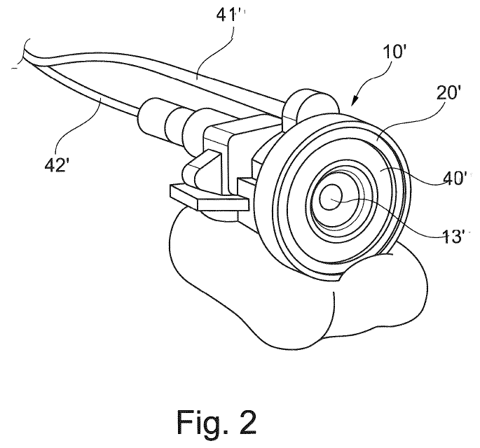

FIG. 2 illustrates a camera device 10′ with cables 41′, 42′ to not shown ultrasonic lens cleaning electronics. The camera device 10′ comprises, below a lens cover, and within a housing 20′, a lens system 13′ and a piezo transduce 40′. Further the camera device 10′ may be configured to be installed into an automotive part like a rear view device or any other camera monitor system with the lens cover of the camera device being installed at the outside of a vehicle and the monitor inside the vehicle.

As all camera-based systems used outside, the camera device 10′ has the problem of getting dirty quickly. In addition, icing, fogging and the like can block the view through the lens system 13′ below the lens cover in a similar way as dirt, wherein all these view blocking substances are referred to as “dirt” in this disclosure. To determine whether dirt is stuck on the lens cover, mass resonance measurements may be used. Since that measures the entire cover lens, false positives can occur because blockages that are not in the field of view (FoV) are also covered.

The piezo transduce 40′ may be activated for removing dirt, with more time being needed e.g. to loosen ice than to loosen fogging or water droplets. A mass resonance measurement may be used after activating the piezo transduce 40′ to detect whether the lens cover is provided with an optical blockage thereon and/or whether a cleaning cycle was successful. If it is then determined that the mass has changed compared to the last cycle, i.e. dirt has been removed, but the original mass before the blockage has still not been reached, an optical blockage detection may be applied.

With an optical blockage detection, it may be visually checked whether there are still blockages on the lens cover in the FoV. The piezo transducer 40′ may also be activated during said detection to improve the optical blockage detection, as water drops are moved by vibrations and can therefore be better detected and directly removed.

In order to determine dirt like e.g. water droplets 50 shown on the lens cover 14 in FIG. 1, a mass detection is conducted. Said mass detection may be in form of a mass resonance measurement which makes usage of the detection of a resonant frequency RF via voltage measurements, with

$$RF = √ ( k / {m}^{′} ) ,$$

wherein m is defining an initial mass, m′ is the initial mass plus dirt (m′=m+dirt), and k is the stiffness or spring constant of the piezo transducer 40 with the lens cover 14.

In case the measured resonant frequency RF is equal to an initial resonant frequency RFo of a clean lens cover 14, m=m′, i.e. there is no dirt on the lens cover 14. But in case there is a change in the measured resonant frequency RF, m≠m′, i.e. there is additional mass, so the lens cover 14 is supposedly dirty or wet.

An optical blockage detection may be conducted by the determination of an optical flow. One possibility is to detect static areas while the camera device 10 is moving, as static areas are generated by dirt sticking on the lens cover 14. Thus, with the camera device 10 being installed at the outside of a vehicle, a movement needed for the optical blockage detection is given when the vehicle has a velocity v above zero (v>0).

Another possibility to detect an optical blockage due to dirt on the lens cover 14 is to utilize the movement or better vibration generated by the piezo transducer 40, without the vehicle having to move, i.e. with v=0. There are two aspects to be taken into consideration in this respect:
A movement of an optical blockage relative to an unchanged background may be detected when a vibration is applied, in particular with a low frequency.
A change in shape of an optical blockage may be detected when a vibration is applied, compared to a non-vibrating state. E.g. an elongation of water droplets occurs at high frequency, as the amplitude can be added due to the fast movement of the lens cover.

As an example, having a pixel size of 3 μm on an imager and using a piezo amplitude of around 50 μm, a dirt particle with a cross-section of 30 μm, which leads to an optical blockage of 10 pixels, will moves by 50 μm. As the exposure of the imager is much smaller than the oscillation frequency of the piezo transducer, the dirt particle is perceived as having a diameter of around 80 μm.

Other algorithms may be used in the static range. i.e. with a vehicle movement, such as AI approaches.

Both above described detection methods do not require any additional hardware, but can be integrated with the existing hardware purely via software. On the one hand, mass resonance measurements are part of a piezo transducer control. And on the other hand, an optical blockage detection is part of a camera control unit.

In case dirt has been detected, via an optical blockage detection after a mass resonance measurement, the decision on when to initiate a cleaning may depend on the amount of pixels on the imager being blocked due to the dirt. Thus, a respective threshold may vary from application to application and is customer-specific.

In the following several examples of a dirt detection and cleaning method are described:

### Example 1: Blockage Present in FoV

If a blockage is detected in the FoV of the camera device that cannot be removed by activating the piezo transducer 40′, various countermeasures may be initiated, alternatively or one after the other, wherein the sequence in principle may vary except for a water cleaning preferably being the last option:
Repeating the activation of the piezo transducer.
Displaying a message to remove dirt.
Activating an air valve, if existing.
Activating a wiper, if existing.
Activating a water valve, if existing.

### Example 2: No Blockage Detected in FoV

If no blockage is detected in the FoV, it may still be that the entire lens cover is blocked or that the system cannot determine the situation, for example due to a poor contrast and lighting conditions when e.g. viewing a white wall which may appear due to fog. The method to determine this is to check the optical flow by checking a pixel movement, with the following two consequences:
If there is no optical flow, countermeasures are initiated in analogy to those described with respect to example 1.
If there is sufficient optical flow, the program ends.

### Example 3: Dirt Check when Car is Parked

There may be two different situations:
When a driver draws a key device of a vehicle, he/she may receive a signal or message to clean the lens cover, in case the lens cover has been detected to be dirty or after the lapse of a certain time period. For the purpose of cleaning, the piezo transduce 40′ may be activated in analogy to embodiment 1 or cleaning means provided by the key device may be used. With respect to the latter, reference is made to the teaching of U.S. Pat. No. 11,077,832 B2.
After boarding the vehicle, a test cycle may be started by activating the piezo transducer to check the cleanliness level of the camera lens cover and then one or more messages or measures are initiated e.g. as described for example 1.

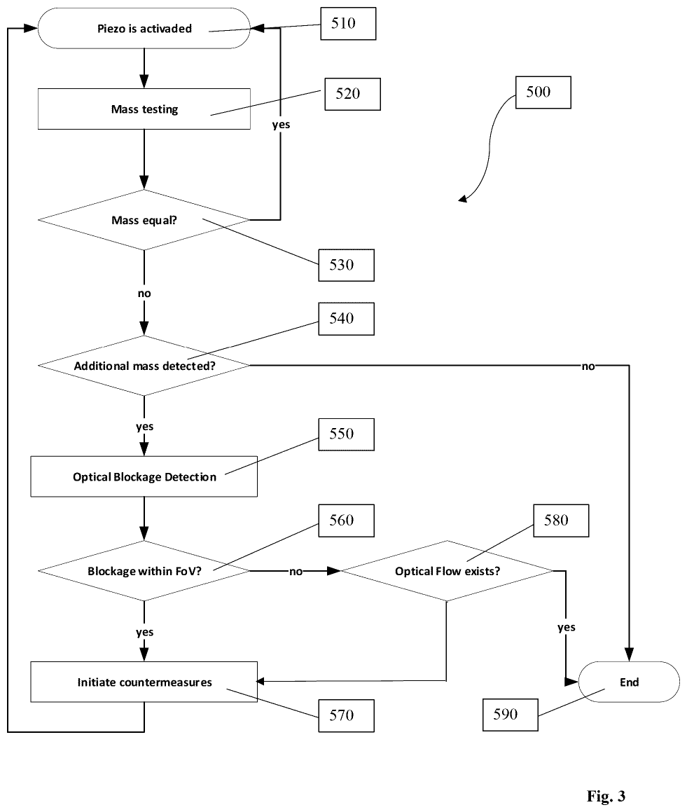

A dirt detection and cleaning method 500 is shown in FIG. 3 with the following steps:
In a first step 510 the piezo transducer is activated for removing dirt.
Then, a mass testing for example via a mass resonance measurement is conducted in a second step 520 to check, whether there still is dirt on the lens cover.
In case it is determined in a third step 530 that the mass has not changed, the piezo transducer is again activated by returning to the first step 510. But in case a change of mass is detected, it is continued to a fourth step 540.
In case no additional mass is detected in the fourth step 540, the method will end by moving to the last step 590. But in case an additional mass is detected, the method proceeds to a fifth step 550.
In the fifth step 550 an optical blockage detection is conducted.
In a sixth step 560 it is determined whether there is a blockage within the FoV.
In case it is determined that there is an optical blockage within the FoV, the method proceeds to a seventh step 570 to initiate one or more countermeasures as described with respect to example 1. For example, the method may return to the first step 510 for initiating a vibration. But in case no countermeasures are to be initiated, the method continues to an eighth step 580 for checking whether an optical flow is existing. It may be determined that the optical flow is disrupted in case static pixel areas on the imager are greater than a specific threshold. This threshold depends on the imager resolution and lens opening angle.
In case it is determined that there is no optical blockage within the FoV during the seventh step 560, the method also continues with the eighth step 580.
In case there is no optical flow detected in the eighth step 580, the method turns to the seventh step 570 to initiate a counter measure as explained with respect to example 1; whereas in case there is an optical flow detected in the eighth step 580, the method turns to the last, ninth step 590, being the end.

The method described with respect to FIG. 3 may be used to differentiate between fogging, mist, fly specks, droplets and ice on the lens cover. The method allows to detect a minimum mass change of 0.014 g and a size of e.g. a droplet starting with a diameter of around 0.3 mm, depending on the camera resolution. Dirt with a mass below 0.014 g and a diameter below 0.3 mm is not detrimental for the functioning of the camera device, as it is not visible by the camera device. These dimensions cover typical dirt particles dissolved in water, and a typical water droplet has a diameter of 0.5 mm. Due to this accurate dirt detection and the different countermeasures to be taken, the amount of water needed for cleaning a cover lens is minimized.

Some further examples of dirt detection and cleaning follow:

### A) Mist

Optically it cannot be distinguish whether there is mist or whether there is fogging on a lens cover. But using a mass resonance measurement method and/or activating a piezo transducer allows a respective distinction. With the mass resonance measurement method, moisture and droplets may be distinguished. If the fogging is very slight, activating the piezo transducer for already 2 seconds is sufficient to remove the fogging. In case, the contrast is not improved significantly during an image inspection after activating the piezo transducer, it is to be concluded that there is mist such that cleaning is to be stopped or not started.

The existence of mist may be verified by driving data such as speed and temperature measurements.

### B) Fly Speaks

The mass resonance measurement method allows to determine fly speaks, but activating a piezo cleaning may not be successful in this case, as it can only remove damp dirt. Activating the piezo transducer while simultaneously monitoring the optical flow through the lens system with the cover lens, provides information on the success of the vibration, and there may be three results:
1. The detected mass reaches its original value of a clean surface because the fly speaks have fallen off.
2. The detected mass decreases, but does not return to the original value, or the mass remains the same. If the mass decreases, the optical flow may increase again. That is, if dirt is partially removed by reducing the mass, the optical flow may return to the focus range. If the optical flow does not detect blockages anymore, the residues of dirt are smaller than 0.3 mm in diameter and therefore no longer need to be taken into account.
3. The detected mass does not decrease such that a different cleaning method must be used, with an air nozzle being activated before activating a water nozzle. That is, vibrations are applied and optical flow is checked again after the air cleaning, and a decision is made as to whether water should be used for further cleaning. If water is used, the piezo transducer activation may be used to remove droplets. To save water, it is also possible to let the droplet move directly to the spot where the dirt was detected such that dry dirt can be loosened before it is removed by vibration.

### D) Droplets

It is sufficient to use only a short impulse for activating the piezo transducer in order to burst a droplet during droplet removal. Two methods of droplet migration may be used: Water is drawn into the center of the lens cover, where it can be burst at maximum energy, or it is pushed out of the FoV so that it is no longer in the field of vision. A combination of both methods may also be used, as dirty water droplets like to leave their dirt on the lens cover after the explosion of the droplet, which can lead to dirt deposits. Further, a large droplet may be broken down into many small droplets that it can no longer be detected.

The water nozzle only has to be activated if the accumulation of dirt after droplet explosion in the center becomes larger than 0.3 mm or the optical flow is blocked by an object.

### E) Ice

The mass resonance measurement method may be used for ice detection, and the piezo transducer may be controlled at a different frequency, with the frequency being higher than for droplets. Due to the vibrations generated by the piezo transducer, ice may be converted into water and may be removed in the same way as described for droplet removal.

In case of thick layers of ice, the piezo transducer may be activated several times, e.g. up to 3 times. Droplet detection may be activated after each cycle, as part of the cycle.

The success of the removal may be verified using an optical flow algorithm and other measures of the vehicle.

While the mass resonance measurement method is about an additional mass that reflects the sum of all mass particles on e.g. the lens cover 14 shown in FIG. 1, the optical flow blockage detection is more about coherent dirt pixels that can actually be seen in the focus. For example, the sum of 20 very small particles may be classified as dangerous in a mass resonance measurement, although in case they are all separated, they are not recognizable in the optical flow because they cannot be focused as individual points. The optical blockage detection therefore allows to recognize a number of static pixels and determine them as a threshold value for cleaning. The algorithm distinguishes between v=0 vibration stroke and v>0 comparison between moving background and static foreground. In both methods, the size of the static pixel is determined and classified.

The size of the smallest recognizable contamination e.g. in form of dirt droplets depends on the focus of the camera and must be calculated individually for different set-ups, each time depending on the lens and resolution. In case dirt droplets are just recognizable a cleaning via vibrations by be sufficient. But in case dirt droplets are strongly recognizable, a cleaning with water may be necessary. Relevant parameters in determining the cleaning method depend on visible dirt area and size of a pixels on imager, being determined by monitored area, in particular distance to be monitored. In case a camera needs to see up to 90 m away, one pixel blocked by dirt may already be a lot, whereas with a monitoring system where only a few meters in front of a vehicle need to be monitored, a plurality of pixels may not be a lot.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

### REFERENCE SIGNS

10, 10′ camera device
11 printed circuit board
12 partial discharge system
13, 13′ lens system
14 lens cover
20, 20 housing
21 recess
30 gasket
40, 40′ piezo transducer
41, 41′ cable
42, 42′ cable
50 water droplets
100 ultrasonic lens cleaning electronics
101 configurable digital signal processor
102 piezo driver
103 power supply pin
104 resistive dividers
105 filters
500 dirt detection and cleaning method
510 to 590 method step

It is claimed:

1. A method for detecting dirt and for cleaning a surface of a lens system or lens cover of a camera device, with at least one piezo transducer mechanically coupled to said surface, the method comprising:
a) activating the at least one piezo transducer for removing dirt via vibrations;
b) determining a result of the dirt removing in step a) via a mass resonance measurement method;
c.1) in case the determined mass has not changed, repeating the sequence of steps a) and b);
c.2) in case the determined mass has been reduced below a first threshold, stopping the method;
c.3a) in case the mass determined in step b) is above a second threshold conducting an optical blockage detection method; and
c.3b) in case an optical blockage is detected in the field of view of the camera device in step c.3a), initiating at least one countermeasure, or in case no optical blockage is detected in the field of view of the camera device in step c.3a), stopping the method.

2. The method of claim 1, wherein the at least one piezo transducer is activated at least partly during the conduction of the mass resonance measurement method for migration and/or burst of particles of dirt.

3. The method of claim 1, wherein
at least one piezo transducer may be controlled at different frequencies,
the mass resonance measurement method may be controlled at different frequencies, and/or
the drive signal frequency of the at least one piezo transducer differs from the frequency used with the mass resonance measurement method.

4. The method of claim 1, wherein a baseline resonant frequency measured for the clean surface with the mass resonance measurement method is compared with the frequency measured in each step of conducting the mass resonance method for the determining the mass or mass change of dirt.

5. The method of claim 1, wherein the at least one piezo transducer is activated at least partly during the conduction of the optical blockage detection method for determining
a movement of an optical blockage relative to an unchanged background, in particular with a low frequency of the at least one piezo transducer, and/or
a change in shape of an optical blockage when a vibration is applied compared to a non-vibrating state, in particular with a high frequency of the at least one piezo transducer.

6. The method of claim 5, wherein
the at least one piezo transducer may be controlled at different frequencies,
the optical blockage detection method may be controlled at different frequencies, and/or
the drive signal frequency of the at least one piezo transducer differs from the frequency used with the optical blockage detection method.

7. The method of claim 1, wherein step a) is initiated
in case an initial dirt mass detection via the mass resonance measurement method determines a mass above a third threshold value,
when activating the camera device,
when approaching a vehicle with the camera device with a key,
when starting the vehicle with the camera device,
after the expiration of a pre-set time interval,
at a certain point of time, or
manually.

8. The method of claim 1 wherein the at least one countermeasures comprises
outputting a signal in form of a message to remove dirt,
activating at least one air valve for removing dirt,
activating at least one mechanical cleaning device, in particular comprising a wiper and/or provided by a key, and/or
activating at least one water valve for removing dirt.

9. The method of claim 8, wherein the kind of countermeasure(s), the amount of countermeasures and/or the sequence of countermeasures depends on
the mass and/or mass change determined by at least one of the steps of conducting the mass resonance measurement method; and/or
the blocked optical flow, the amount of visible dirt, the amount and/or size of blocked pixels of an image area, the resolution of the image area and/or an area monitored by the camera device.

10. The method of claim 8, wherein the activation of the at least one water valve is the last countermeasure selected in a sequence of countermeasures.

11. The method of claim 1, wherein after the at least one countermeasure the at least one piezo transducer is activated, a further resonance mass measurement method is conducted and/or a further optical blockage detection method is conducted.

12. A device for detecting dirt and for cleaning a surface of a lens system or lens cover of a camera device, with at least one piezo transducer mechanically coupled to said surface, wherein the device is adapted to conduct the method of claim 1.

13. The device of claim 12, comprising
ultrasonic surface cleaning electronics with at least one configurable digital signal processor, a piezo driver connected to the at least one piezo transducer of the camera device, at least one power supply pin and an evaluation module.

14. The device of claim 13, wherein the ultrasonic surface cleaning electronics comprises a pulse width generator and a pulse width controller and/or at least one sensor comprising a current sensor, a voltage sensor and/or a temperature sensor.

15. The device of claim 12, wherein the camera device comprises a housing, a printed circuit board with at least one optical sensor, a lens cover, the lens system and the piezo transducer mechanically connected to the lens cover and arranged within the housing.

16. The device of claim 15, wherein the lens system is arranged between the lens cover and the printed circuit board or comprise the lens cover.

17. The device of claim 12, wherein the piezo transducer has a ring form and/or at least partly embraces the lens system.

18. The device of claim 15, wherein the housing is formed with a recess, wherein the lens cover and the piezo transducer extend into the recess with an elastic sealing means being arranged between the housing and the lens cover.

19. An automotive part in form of a rear view device and/or drive assistance device of a motor vehicle, with at least one device according to claim 12.

20. An autonomously driving vehicle, with an automotive part of claim 19.

21. The autonomously driving vehicle of claim 20, wherein at least one vehicle sensor output and/or driving data are controlling the piezo transducer vibration, the mass resonance measurement method and/or the optical blockage detection method.
